(19) United States
(12) Patent Application Publication
(10) Pub. No.: US 2001/0055976 A1
(43) Pub. Date: Dec. 27, 2001

(54) Retrieval of location-related information

(76) Inventors: Simon Edwin Crouch, Bristol (GB); Lawrence Wilcock, Malmesbury (GB); James Thomas Edward McDonnell, Bristol (GB); Rycharde Jeffery Hawkes, Bristol (GB)

Correspondence Address: LADAS & PARRY, Suite 2100, 5670 Wilshire Boulevard, Los Angeles, CA, 90036-5679, US

(21) Appl. No.: 09/858,148

(22) Filed: May 15, 2001

(30) Foreign Application Priority Data
May 16, 2000 (GB) 0011643.4

(51) Int. Cl. H04Q 7/20

(52) U.S. Cl. 455/456; 455/41; 342/357.01

(57) ABSTRACT

A cell phone (20Z) is provided with a short-range wireless transceiver (28). This transceiver is used to pick up local information from local transmitters (51B). In many instances this local information is insufficient to locate the user, being, for example, information about the local branch of a business (50B) having many branches. However, by combining this local information with a locality indicator, such as current cell ID for the cell in which the cell phone (20Z) is camped, it is much more likely that the location of the user can be established without ambiguity. A service system (40) is provided that has a database (42) searchable by locality indicator and local information to provide the user's current location. As well as, or alternatively to, providing user location, the database (42) can be used to provide information about the locality of the user or about the party controlling the local transmitter (51B) from which the local information was obtained.

### FIELD OF THE INVENTION

The present invention relates to a method, mobile device and system for the retrieval of location-related information such as, for example, location information or information about a local business or landmark.

### BACKGROUND OF THE INVENTION

Communication infrastructures suitable for mobile users (in particular, though not exclusively, cellular radio infrastructures) have now become widely adopted. Whilst the primary driver has been mobile telephony, the desire to implement mobile data-based services over these infrastructures, has led to the rapid development of data-capable bearer services across such infrastructures. This has opened up the possibility of many Internet-based services being available to mobile users.

By way of example, FIG. 1 shows one form of known communication infrastructure for mobile users providing both telephony and data-bearer services. In this example, a mobile entity 20, provided with a radio subsystem 22 and a phone subsystem 23, communicates with the fixed infrastructure of GSM PLMN (Public Land Mobile Network) 10 to provide basic voice telephony services. In addition, the mobile entity 20 includes a data-handling subsystem 25 interworking, via data interface 24, with the radio subsystem 22 for the transmission and reception of data over a data-capable bearer service provided by the PLMN; the data-capable bearer service enables the mobile entity 20 to communicate with a service system 40 connected to the public Internet 39. The data handling subsystem 25 supports an operating environment 26 in which applications run, the operating environment including an appropriate communications stack.

More particularly, the fixed infrastructure 10 of the GSM PLMN comprises one or more Base Station Subsystems (BSS) 11 and a Network and Switching Subsystem NSS 12. Each BSS 11 comprises a Base Station Controller (BSC) 14 controlling multiple Base Transceiver Stations (BTS) 13 each associated with a respective “cell” of the radio network. When active, the radio subsystem 22 of the mobile entity 20 communicates via a radio link with the BTS 13 of the cell in which the mobile entity is currently located. As regards the NSS 12, this comprises one or more Mobile Switching Centers (MSC) 15 together with other elements such as Visitor Location Registers 32 and Home Location Register 32.

When the mobile entity 20 is used to make a normal telephone call, a traffic circuit for carrying digitised voice is set up through the relevant BSS 11 to the NSS 12 which is then responsible for routing the call to the target phone (whether in the same PLMN or in another network).

With respect to data transmission to/from the mobile entity 20, in the present example three different data-capable bearer services are depicted though other possibilities exist. A first data-capable bearer service is available in the form of a Circuit Switched Data (CSD) service; in this case a full traffic circuit is used for carrying data and the MSC 32 routes the circuit to an Inter working Function IWF 34 the precise nature of which depends on what is connected to the other side of the IWF. Thus, IWF could be configured to provide direct access to the public Internet 39 (that is, provide functionality similar to an LAP—Internet Access Provider IAP). Alternatively, the IWF could simply be a modem connecting to a PSTN; in this case, Internet access can be achieved by connection across the PSTN to a standard IAP.

A second, low bandwidth, data-capable bearer service is available through use of the Short Message Service that passes data carried in signalling channel slots to an SMS unit which can be arranged to provide connectivity to the public Internet 39.

A third data-capable bearer service is provided in the form of GPRS (General Packet Radio Service which enables IP (or X.25) packet data to be passed from the data handling system of the mobile entity 20, via the data interface 24, radio subsystem 21 and relevant BSS 11, to a GPRS network 17 of the PLMN 10 (and vice versa). The GPRS network 17 includes a SGSN (Serving GPRS Support Node) 18 interfacing BSC 14 with the network 17, and a GGSN (Gateway GPRS Support Node) interfacing the network 17 with an external network (in this example, the public Internet 39). Full details of GPRS can be found in the ETSI (European Telecommunications Standards Institute) GSM 03.60 specification. Using GPRS, the mobile entity 20 can exchange packet data via the BSS 11 and GPRS network 17 with entities connected to the public Internet 39.

The data connection between the PLMN 10 and the Internet 39 will generally be through a firewall 35 with proxy and/or gateway functionality.

Different data-capable bearer services to those described above may be provided, the described services being simply examples of what is possible.

In FIG. 1, a service system 40 is shown connected to the Internet 40, this service system being accessible to the OS/application 26 running in the mobile entity by use of any of the data-capable bearer services described above. The data-capable bearer services could equally provide access to a service system that is within the domain of the PLMN operator or is connected to another public or private data network.

With regard to the OS/application software 26 running in the data handling subsystem 25 of the mobile entity 20, this could, for example, be a WAP application running on top of a WAP stack where “WAP” is the Wireless Application Protocol standard. Details of WAP can be found, for example, in the book “Official Wireless Application Protocol” Wireless Application Protocol Forum, Ltd published 1999 Wiley Computer Publishing. Where the OS/application software is WAP compliant, the firewall will generally also serve as a WAP proxy and gateway. Of course, OS/application 26 can comprise other functionality (for example, an e-mail client) instead of, or additional to, the WAP functionality.

The mobile entity 20 may take many different forms. For example, it could be two separate units such as a mobile phone (providing elements 22-24) and a mobile PC (data-handling system 25) coupled by an appropriate link (wireline, infrared or even short range radio system such as Bluetooth). Alternatively, mobile entity 20 could be a single unit such as a mobile phone with WAP functionality. Of course, if only data transmission/reception is required (and not voice), the phone functionality 24 can be omitted; an example of this is a PDA with built-in GSM data-capable functionality whilst another example is a digital camera (the data-handling subsystem) also with built-in GSM data-capable functionality enabling the upload of digital images from the camera to a storage server.

Whilst the above description has been given with reference to a PLMN based on GSM technology, it will be appreciated that many other cellular radio technologies exist and can typically provide the same type of functionality as described for the GSM PLMN 10.

Recently, much interest has been shown in “location-based”, “location-dependent”, or “location-aware” services for mobile users, these being services that take account of the current location of the user (or other mobile party). A number of methods exist for determining the location of a mobile user as represented by an associated mobile equipment. Some of these methods, such as the use of a GPS system result in the user knowing their location thereby enabling them to transmit it to a location-aware service they are interested in receiving; other of the methods, such as the use of a PLMN location server described below in relation to FIG. 2, result in the user's location becoming known to a network entity from where it can be supplied either to the mobile user or directly to a location-aware service (generally only with the consent of the user concerned).

FIG. 2 depicts two general approaches to location determination from signals present in a cellular radio infrastructure. First, however, it can be noted that in general both the mobile entity and the network will know the identity of the cell in which the mobile entity currently resides, this information being provided as part of the normal operation of the system. (Although in a system such as GSM, the network may only store current location to a resolution of a collection of cells known as a “location area”, the actual current cell ID will generally be derivable from monitoring the signals exchanged between the BSC 14 and the mobile entity). Beyond current basic cell ID, it is possible to get a more accurate fix by measuring timing and/or directional parameters between the mobile entity and multiple BTSs 15, these measurement being done either in the network or the mobile entity (see, for example, International Application WO 99/04582 that describes various techniques for effecting location determination in the mobile and WO 99/55114 that describes location determination by the mobile network in response to requests made by location-aware applications to a mobile location center-server—of the mobile network).

The left-hand half of FIG. 2 depicts the case of location determination being done in the mobile entity 20A by, for example, making Observed Time Difference (OTD) measurements with respect to signals from BTSs (Base Transceiver Stations) 15 and calculating location using a knowledge of BTS locations. The location data is subsequently appended to a service request 36 sent to service system 40 in respect of a location-aware service. The calculation load on mobile entity 11C could be reduced and the need for the mobile to know BTS locations avoided, by having a network entity do some of the work. The right-hand half of FIG. 2 depicts the case of location determination being done in the network, for example, by making Timing Advance measurements for three BTSs 15 and using these measurements to derive location (this derivation typically being done in a unit associated with BSC, Base Station Controller, 16). The resultant location data is passed to a location server 30 from where it can be made available to authorised services. When the mobile entity 20B of FIG. 2 wishes to invoke a location-aware service available on service system 40, it sends a request 37 including an authorisation token and its ID (possible embedded in the token) to the service system 40; the service system then uses the authorisation token to obtain the current location of the mobile entity 11D from the location server 30 (see arrow 38). The service system 40 can be pre-authorised to access the location server 30

Both of the location discovery methods of FIG. 2 have certain disadvantages so far as the user is concerned. In the case where the mobile itself determines its location, additional complexity (and thus cost) is added to the mobile device, whereas in the case where location discovery is done in the network, it is likely that the PLMN operator will charge for this service.

In the near future, it can be expected that mobile devices, including cell phones, will become available equipped with short-range wireless systems for device-to-device communication. This gives rise to the possibility of businesses offering their goods and services through short-range communication to passers-by carrying suitable mobile devices. A number of technologies exist for the short range communication of information to and between mobile devices. These technologies include infra-red based technologies and low-power radio technologies (including, in particular, the recent “Bluetooth” short range wireless standard). Depending on the technology implementation, differing types of message propagation will be enabled including asynchronous message broadcast, and multicast and point-to-point duplex connections established after coordination and negotiation between communicating devices.

The information offered by businesses through these short range wireless (including IR) portals will generally initially correspond to that available on the website of the business provided such a website exists. However, it is likely that short-range wireless portals, requiring no governmental licensing and capable of installation by the business owner himself, could proliferate and become a major source of local service information that is not to be found on the web.

In our co-pending UK Patent Application No. 0007940.0 (filed Apr. 1 2000), a method is described of collecting information from short-range wireless portals and cataloguing this information at a service system to enable web users to access the information. FIG. 3 of the accompanying illustrates the method described in the aforesaid co-pending Application. More particularly, FIG. 3 shows three business premises 50A, 50B and 50C of businesses A, B and C respectively, each business premise 50A, 50B and 50C being equipped with a short-range wireless portal 51A, 51B, 51C by means of which passers-by can obtain information about the goods and services available through the business concerned. This information can be text based or more graphically oriented, presenting pages such as those found on the web; the precise form in which information is presented will depend on the capabilities generally available in the target receiving devices. At least a portion of the information can be structured in tagged information fields.

To gather information from the portals for use in a database service system 40, a mobile device 20X provided with a short-range wireless transceiver 28 is moved within range of a portal. A gatherer program 27 running in a data-handling sub-system 25 of the mobile is responsible for collecting information from the portal about the goods and services available from the business operating the portal, and for sending this information, together with location data about the portal, to the service system via the cellular radio network 10. It will be appreciated that providing structure to the information transmitted by the portal facilitates storage and retrieval of specific information items in the service system 40. As regards the location data, whilst some portals may include location data in their transmissions, this will often not be the case, it usually being judged unnecessary; the mobile device 20X is therefore preferably arranged to provide the location information itself by using, for example, one of the location discovery technique illustrated in FIG. 2.

Where a user having a mobile device like device 20X (that is, one with both a cellular radio capability and a short-range wireless capability) wishes to discover their location but does not have an in-built location determining means, then it would be useful to have an alternative to having to consult a PLMN location server. One possible source of location data is a local short-range wireless portal but, as already indicated, these portals may well not send out location data, at least not as such. However, a short-range wireless portal is almost certain to be sending out local information which can be a clue as to location. Unfortunately, the local information is unlikely to be a reliable indicator of location not least because branches of the same business may well be transmitting the same information through their respective wireless portals.

It is an object of the present invention to provide for the retrieval of location-related information by a mobile device that has both wide-area and short-range communication sub-systems.

### Summary of the Invention

According to the present invention, there is provided a method of retrieving location-related information using a mobile device having both wide-area and short-range communication sub-systems, the method involving:

obtaining a locality indicator using the wide-area communication sub-system;

obtaining local information using the short-range communication sub-system;

using the locality indicator and local information in combination to retrieve specific information having a relation to the current location of the mobile device.

The wide-area communication sub-system is, for example, a cellular radio sub-system in which case the locality indicator can be the cell ID or location area of the radio cell where the mobile device is currently located.

According to another aspect of the present invention, there is provided a mobile device comprising:

a wide-area communication sub-system;

a first data-capture arrangement for capturing a locality indicator using the wide-area communication sub-system;

a short-range communication sub-system;

a second data-capture arrangement for capturing local information using the short-range communication sub-system; and

an arrangement for using the captured locality indicator and local information in combination to retrieve specific information having a relation to the current location of the mobile device.

According to a further aspect of the present invention, there is provided a method of providing an information service in which items of information derived from short-range wireless transmitters are stored together with respective locality indicators each indicating the locality of the transmitter from where the corresponding item of information was derived.

According to a still further aspect of the present invention, there is provided a service system comprising:

a database in which items of local information derived from short-range wireless transmitters are stored together with respective further information and respective locality indicators each indicating the locality of the transmitter from where the corresponding item of information was derived;

a communications interface for interfacing the service system with a communications infrastructure; and

a request handler for receiving a request via the communications interface for specific information having a relation to a location indicated by a locality indicator and local information included in the request, the request handler being operative to use said locality indicator and local information included in the request to find a match in the database and to return from the said further information associated with the match, the requested specific information.

### BRIEF DESCRIPTION OF THE DRAWINGS

A method and service-system, both embodying the present invention, for the retrieval of location-related information, will now be described, by way of non-limiting example, with reference to the accompanying diagrammatic drawings, in which:

FIG. 1 is a diagram of a known communications infrastructure usable for transferring voice and data to/from a mobile entity;

FIG. 2 is a diagram illustrating known ways of determining the location of a mobile entity using signals present in a cellular mobile radio communications system;

FIG. 3 is a diagram showing the gathering of information by a mobile device as it passes three short-range wireless portals, this information being passed back to a database system;

FIG. 4 is a diagram illustrating the retrieval of location-related information by a mobile device on the basis of data derived from a wireless portal and a cellular radio infrastructure; and

FIG. 5 is a diagram showing the main steps carried out by a retrieval program of the FIG. 4 mobile device, these steps being an embodiment of the method of the invention.

### BEST MODE OF CARRYING OUT THE INVENTION

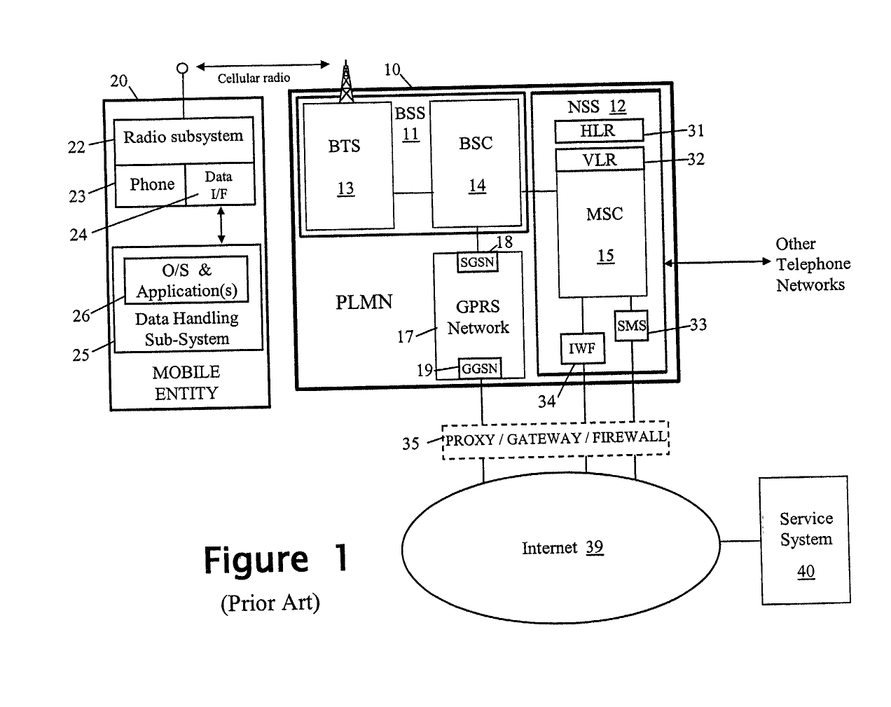

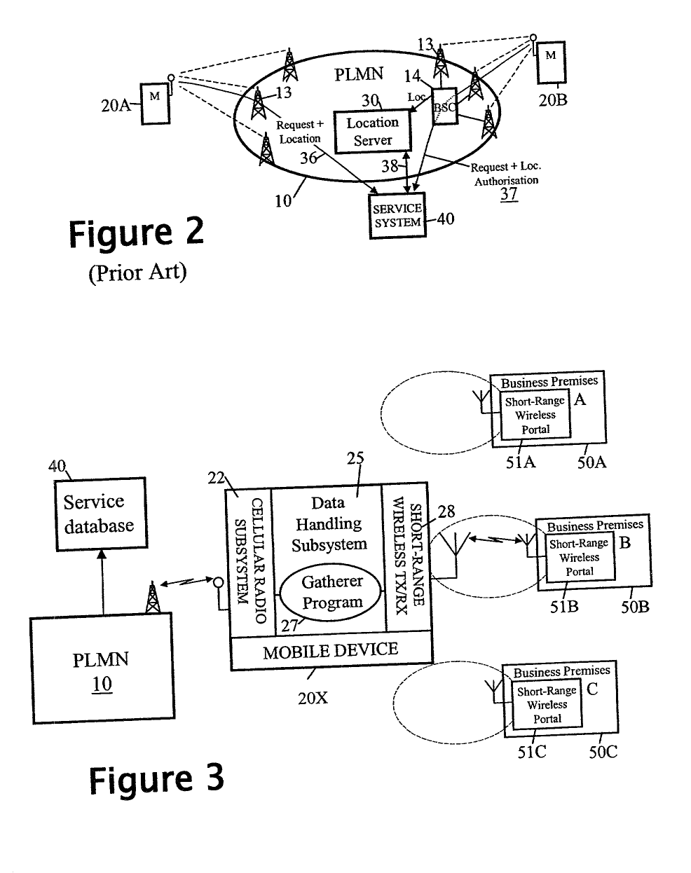

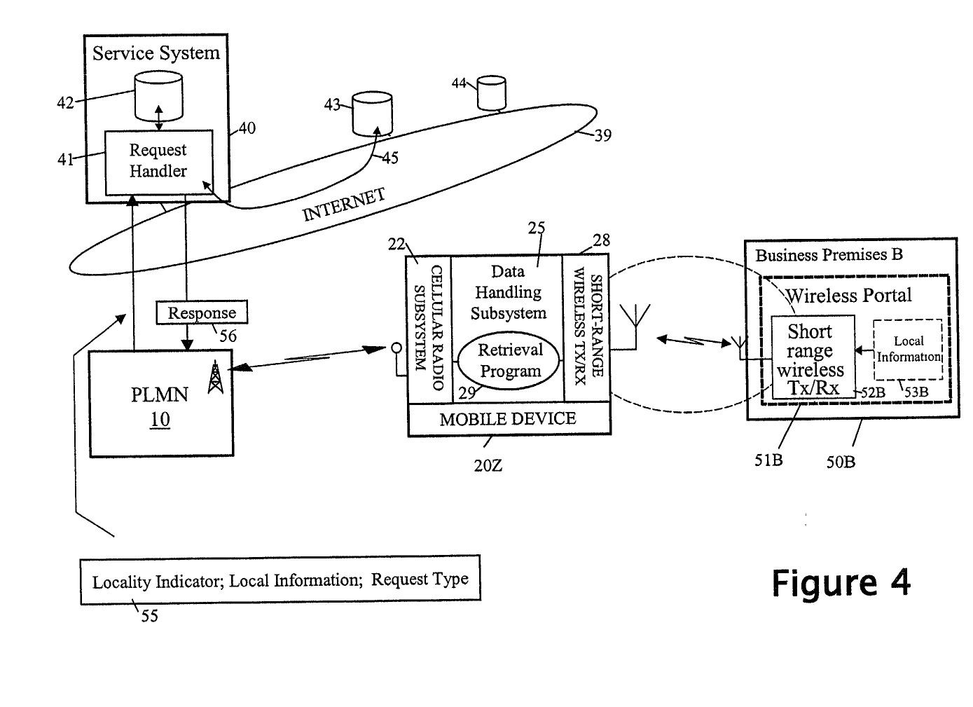

The information-retrieval method and related service system embodying the invention will now be described with reference to FIG. 4 which shows the service system 40 as connected to the public Internet 39. It is to be understood that the present invention is not limited to the specifics of the mobile entity and communication infrastructure shown in FIG. 4 and the generalisations discussed above in relation to FIG. 1 regarding these elements apply equally to the operational context of the service system 40. Furthermore, whilst the service system 40 is shown as connected to the public Internet, it could be connected to the GPRS network 17 or to another fixed data network interfacing directly or indirectly with the network 17 or network 39.

FIG. 4 shows a short-range wireless portal 51B situated at a business premises 50B of a business B. The portal 51B comprises short-range wireless transceiver 52B operative to transmit local information 53B to nearby short-range receivers; the transceiver can use a short-range radio technology such as Bluetooth, infra-red technology, or any other suitable short-range communications technology. The local information is, for example, information about the portal and the associated business B (such as a portal identifier, the identity of the business, contact details, and goods and services offered by the business), information about local landmark(s), or other information having a relationship to the locality where the wireless portal 51B is situated. This local information can be text based or more graphically oriented, presenting pages such as those found on the web; the precise form in which information is presented will depend on the capabilities generally available in the target receiving devices. At least a portion of the information can be structured, for example, in tagged information fields (such as in an XML document) or as name-value pairs.

Also shown in FIG. 4 is a device 20Z similar to device 20X of FIG. 3. Device 20Z comprises the following three main subsystems:

a short-range wireless transceiver subsystem 21 for communicating with the wireless portals such as portal 51B.

a cellular radio subsystem 22 for sending and receiving data over a data-capable bearer service of PLMN 10.

a data-handling subsystem 25 that interfaces with both the short-range wireless transceiver subsystem 21 and the cellular radio subsystem 22 via appropriate interfaces. The data-handling subsystem 25, when so instructed by the device user through a device user interface (not shown), runs a retrieval program 29 for requesting retrieval of specific local information from a service system 40. In the present case, the user can select one of three different types of specific information to be retrieved, as will be more fully explained below.

The data-handling subsystem 25 will generally be integrated with the other subsystems 21 and 22 into a single device; however, it would be possible to provide the subsystems in two or more separate physical elements appropriately linked together to operate as a single device.

The service system 40 is connected to the internet 39 and comprises a database 42 and a request handler 41. The database 42 holds a plurality of records each of which relates to a respective short-range wireless portal (such as portal 51B) and contains characterising data for the portal in the form of:

a cell ID indicative of which cell of PLMN 10 provides primary cover for the locality in which the portal concerned resides;

data about the local information transmitted by the portal, this data being, for example, extracts of the transmitted information (such as a portal identifier), a list of key words contained in the local information, etc.

In addition, each portal record contains certain specific information intended to be returned in response to a matching request made to the service system; in the present example, this specific information comprises:

(a)-the location of the portal;

(b)-the web URL of the website of the business (or other entity) in charge of the portal concerned;

(c)-the location of the nearest cash dispenser (ATM).

A party using the service system provides portal characterising data (cell ID, data about the local information transmitted by the portal) in their request; the request also includes a request-type indicator indicative of whether the requestor requires specific information (a), (b) or (c). The request handler 41, on receiving the request, searches database 42 for a portal with characterising data matching that contained in the request and on finding a match, extracts and returns the appropriate specific information as indicated by the request-type indicator. Where a request contains the local-information data in the form of an extract of the transmitted local information, the request handler may first process the extract to identify key elements (such as key words or the values of specific name-value pairs) that correspond to the form in which the characterising data is stored in database 42.

In the event that the characterising data contained in a request is inadequate to uniquely match a portal record (either because no match can be found or because multiple matches are found), the request handler can be arranged to request further information from the requestor with a view to identifying a match/selecting between the matches found.

Database 42 is populated using, for example, a method similar to that described in our above-mentioned co-pending patent application, with the additional collection of cell ID information in respect of the location of each portal recorded. Alternative methods can also be used to populate database 42—indeed, it is not essential to capture the local information actually broadcast by the portal as in many cases it will simply be sufficient to know in general terms what information is being transmitted (for example, information about a particular business or landmark).

Database 42 may be arranged to hold only the records of portals within certain PLMN cells, records for portals in other cells being held in other database servers 43, 44. In this case, it is the responsibility of the request handler to access the appropriate database server having regard to the cell ID contained in a request. A similar distributed database arrangement can be used in respect of cell IDs associated with different PLMNs—thus, if a request is received for a cell ID of a different PLMN to that for which database 42 holds portal records, it is the request handler 41 that is responsible for contacting the database holding portal records for the PLMN concerned.

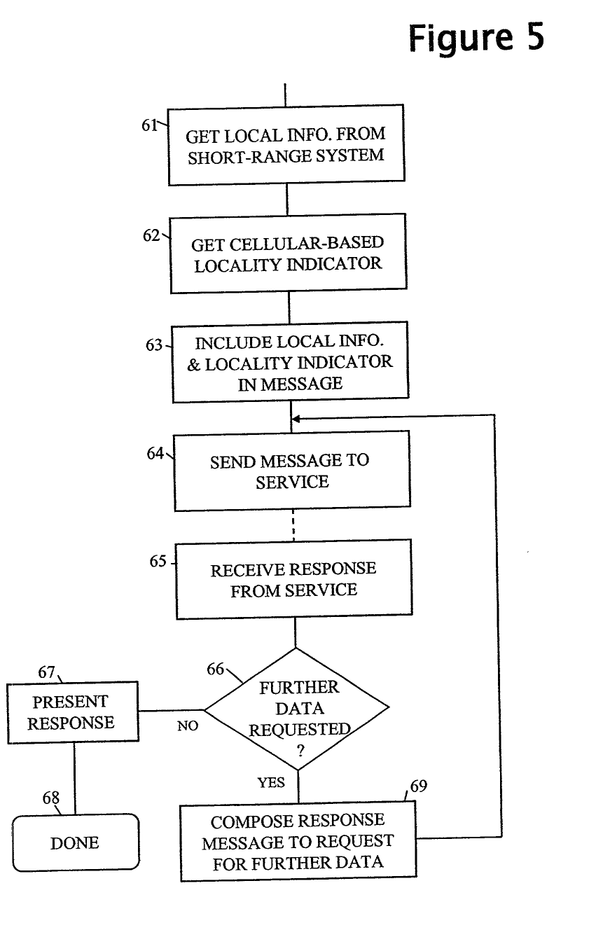

The operation of the device 20Z for the retrieval of specific local information will now be described with reference to FIG. 5 that shows the main steps carried out by the retrieval program 26.

A user equipped with device 20Z wishes to know their location. The user is adjacent wireless portal 51B and activates the retrieval program 29 of device 20Z and indicates (using a user interface of the device 20Z) that location-type specific information is to be retrieved. The program 29 then controls the capture of characterizing data in respect of the portal 51B by first capturing local information transmitted from portal 51B (step 61) and then ascertaining the cell ID of the PLMN cell in which the device 20Z is currently camped (step 62). The characterizing data is now included into request message 55 along with a request type indicator indicating that location information is required (step 63). Message 55 (see FIG. 4) is then sent via a data-capable bearer service of PLMN 10 and internet 39 to the service system 55. The request handler 41 of service system processes the request in the manner indicated above, matching the characterizing data in the request message 55 with that held in the corresponding portal record in database 42 and then returning the location of the portal in a response message 56. The response message 56 is received back by device 56Z (step 67) and assuming that the service system has not requested further information (checked in step 66), the location information is presented to the user via the device user interface (step 68) and the retrieval program terminated (step 68).

In the event of the request handler requesting further data upon which to make a unique match, this further-data request is detected at step 66 and further data obtained either from the local information transmitted by portal 51B (step 69) or through user input. The further data is then sent back to the service system (step 64).

The user may also decide to request the other types of specific information held by database 42 in which case a corresponding request is made including an appropriate request-type indicator.

It will be appreciated that many variants are possible to the above-described information retrieval method and service system. For example, the characterising data captured by device 20Z in steps 61 and 62 can be stored in device 20Z and the information-retrieval request made to service system at a later time when more convenient to the user. This is particularly useful where the information to be retrieved is information intended for subsequent use, such as the URL of the business website. Whilst in the above-described service system, information such as the nearest cash dispenser (ATM) has been described as being held in the portal records, such information could alternatively held in a location-indexed resource database (for example, separate from database 42) and accessed using the portal location contained in a matched portal record. In this case, where a request relates to information of the type held by the location-indexed database, the request handler 41 will first retrieve from database 42 the location of the portal indicated in a request and then use this location as the key to look up the requested information in the location-indexed database.

With respect to the locality identifier constituted by PLMN cell ID in the above-described embodiment, this identifier could alternatively be the location area (at least for a GSM PLMN 10). Other locality indicators can alternatively be user such as an approximate location fix obtained using a GPS system or even a user input post code (zip code) for the locality.

1. A method of retrieving location-related information using a mobile device having both wide-area and short-range communication sub-systems, the method involving:
obtaining a locality indicator using the wide-area communication sub-system;
obtaining local information using the short-range communication sub-system;
using the locality indicator and local information in combination to retrieve specific information having a relation to the current location of the mobile device.

2. A method according to claim 1, wherein said local information is information about a local business or landmark.

3. A method according to claim 1, wherein said local information is an identifier of a short-range transmitter the transmissions of which are received by the mobile device.

4. A method according to claim 1, wherein the step of using the local information and locality indicator to retrieve said specific information is effected by searching for a match in a database in which local information entries are tagged with respective locality indicators indicative of the locality associated with the local information of the entry concerned.

5. A method according to claim 4, wherein the database is held remotely, the mobile device using the wide-area communication sub-system to pass the local information and locality indicator to a service system which then accesses the database to retrieve said specific information and return it to the device using the wide-area communication subsystem of the latter.

6. A method according to claim 5, wherein the database entries are distributed across multiple database servers on the basis of their respective locality indicators, the appropriate server being accessed by the service system according to the locality indicator received from the mobile device.

7. A method according to claim 1, wherein said specific information is location.

8. A method according to claim 1, wherein said specific information is information about the source that transmitted the local information to the mobile device.

9. A method according to claim 1, wherein said specific information is supplemental information about the same topic as said local information.

10. A method according to claim 1, wherein the wide-area communication sub-system comprises a cellular radio sub-system.

11. A method according to claim 10, wherein said locality indicator comprises an identifier of the current cell in which the mobile device is camped.

12. A method according to claim 1, wherein the wide-area communication sub-system comprises a GPS receiving system, the locality indicator being an approximate location reading.

13. A method according to claim 1, wherein the short-range communication sub-system is a short-range radio transceiver.

14. A method according to claim 1, wherein the short-range communication sub-system is an infra-red based system.

15. A method according to claim 1, wherein the obtained locality indicator and local information are stored in the mobile device and subsequently used to retrieve said specific information at a time convenient to the user.

16. A mobile device comprising:
a wide-area communication sub-system;
a first data-capture arrangement for capturing a locality indicator using the wide-area communication sub-system;
a short-range communication sub-system;
a second data-capture arrangement for capturing local information using the short-range communication sub-system; and
an information-retrieval arrangement for using the captured locality indicator and local information in combination to retrieve specific information having a relation to the current location of the mobile device.

17. A device according to claim 16, wherein the second data-capture arrangement is operative to capture, as said local information, an identifier of a short-range transmitter the transmissions of which are received by the short-range communications sub-system.

18. A device according to claim 16, wherein the retrieval arrangement is operative to use the wide-area communication sub-system to pass the local information and locality indicator to a service system and to receive back said specific information from the service system.

19. A device according to claim 16, wherein the wide-area communication sub-system comprises a cellular radio sub-system.

20. A device according to claim 16, wherein the short-range communication sub-system is a short-range radio transceiver.

21. A device according to claim 16, wherein the captured locality indicator and local information are stored in the mobile device and subsequently used by the retrieval arrangement to retrieve said specific information at a time convenient to the user.

22. A method of providing an information service in which items of information derived from short-range wireless transmitters are stored together with respective locality indicators each indicating the locality of the transmitter from where the corresponding item of information was derived.

23. A method according to claim 22, wherein said locality indicator is a location area or cell identifier for a mobile radio cell in which the corresponding transmitter is located.

24. A service system comprising:
a database in which items of local information derived from short-range wireless transmitters are stored together with respective further information and respective locality indicators each indicating the locality of the transmitter from where the corresponding item of information was derived;
a communications interface for interfacing the service system with a communications infrastructure; and
a request handler for receiving a request via the communications interface for specific information having a relation to a location indicated by a locality indicator and local information included in the request, the request handler being operative to use said locality indicator and local information included in the request to find a match in the database and to return from the said further information associated with the match, the requested specific information.

25. A service system according to claim 24, wherein said locality indicators are location area or cell identifiers for a mobile radio cell.

26. A service system according to claim 24, wherein said items of local information are identifiers of the respective related said short-range transmitters.
